(19) United States
(12) Patent Application Publication
(10) Pub. No.: US 2024/0273353 A1
(43) Pub. Date: Aug. 15, 2024

(54) DIRECTIONAL DRIVERS OF DEEP LEARNING MODELS BASED ON MODEL GRADIENTS

(71) Applicant: THE BANK OF NEW YORK MELLON, New York, NY (US)

(72) Inventor: Philipp RIEDER, New York, NY (US)

(21) Appl. No.: 18/166,696

(22) Filed: Feb. 9, 2023

(51) Int. Cl. G06N 3/08

(52) U.S. Cl. CPC G06N 3/08

(57) ABSTRACT

The disclosure relates to systems and methods of determining gradient-based directional drivers of deep learning models. A system may access a plurality of features and a group definition that specifies one or more groups of features. The system may provide the plurality of features as input to a deep learning model trained to generate a model output based on a model function and the plurality of features. The system may obtain, for each feature, a gradient that represents a rate of change of the model function based on the feature and then aggregate, based on the group definition, the gradients obtained from the deep learning model; and for each group of features from among the one or more groups of features: determine a directional driver based on the aggregated gradients, the directional driver indicating an impact of the group of features on the model output.

### BACKGROUND

Deep learning models such as neural networks are becoming increasingly sophisticated and complex, oftentimes using large numbers of features for training and execution. This complexity results in outputs that are oftentimes difficult to interpret. Thus, many of these deep learning models are considered “black boxes” because model inputs may not be traceable to model outputs. In particular, high feature dimensionality results in outputs that are not manageable and hard to interpret for humans. Furthermore, some features may be derived from the same variable but feature-based training and execution makes it difficult to quantify the impact of a variable on model outputs. Another issue may arise in a time series because of the complexity of sequence dependence among the input variables. Thus, it may be difficult to quantify the impact of the variable (or its related features) on the entire sequence. These and other issues exist with deep learning models.

### SUMMARY

Various systems and methods may address the foregoing and other problems. For example, a system may address the problem of high feature dimensionality by grouping features into variables and/or grouping variables into variable groups. Doing so may enable aggregate feature analysis when executing deep learning models. For example, a group definition may identify features that are to be grouped into variables and/or variables that are to be grouped into variable groups. A system may use the group definition to group features into variables, in which each variable will have a group of one or more features. The system may also use the group definition to group variables into variable groups, in which each variable group will have a group of one or more variables and their associated features.

The system may address the difficulty of quantifying the impact of a variable on model outputs by using gradients of model outputs and aggregating the gradients based on the groupings. A gradient is a rate of change of a model function based on an input. The model function may be used by the deep learning model to generate the model output. Thus, gradients may represent the effect of an input, which may be derived based on a feature, on the output of the model function and therefore the model output. In some examples, the gradients associated with features may be aggregated to corresponding variables. In some examples, each variable's aggregated gradients associated with the variable's corresponding features may be further aggregated with other variable's aggregated gradients to corresponding variable groups.

The system may address the difficulty of quantifying the impact of the variable (or its related features) on the entire sequence in a time series by collapsing an N-dimensional data object having gradients, such as an N-dimensional tensor, over a temporal dimension and then aggregating the gradients based on the collapsed N−1-dimensional data object. Doing so over time periods may improve the explainability of model outputs in data sequences.

In an example operation, the system may access features for input to a deep learning model. The system may activate gradient monitoring on an N-dimensional tensor object that includes at least a temporal dimension, where Nis an integer greater than two. Other dimensions may include batch size, the features, and/or other dimensions. Gradient monitoring may be activated via a gradient function of a deep learning platform (“platform”) that executes the deep learning model.

The system may execute the deep learning model with gradient monitoring based on the features. The system may generate model outputs based on the executed deep learning model, and access the gradients. The system may collapse a temporal dimension of the tensor object to result in N−1 dimensions. The system may then aggregate feature gradients based on feature groups defined in the group definition. The system may identify directional drivers of each variable and/or variable group based on their aggregated feature gradients.

In another example operation, the system may access a plurality of features and a group definition that specifies one or more groups of features. The system may provide the plurality of features as input to a deep learning model trained to generate a model output for the time period based on a model function and the plurality of features. For each feature from among the plurality of features, the system may obtain, from the deep learning model, a gradient that represents a rate of change of the model function based on the feature.

The system may aggregate, based on the one or more groups of features, the gradients obtained from the deep learning model. For each group of features from among the one or more groups of features, the system may determine a directional driver based on the aggregated gradients, the directional driver indicating an impact of the group of features on the model output. A directional driver is a data value that indicates a feature, variable, and/or variable group's impact on a model output of a deep learning model. In some instances, the directional driver is a vector value in that the directional driver may indicate a magnitude of the impact and/or direction of the impact.

The various systems and methods described herein may improve the way in which model outputs are understood through the directional drivers. These systems and methods may further improve feature selection, which may enable fine-tuned deep learning models.

### BRIEF DESCRIPTION OF THE DRAWINGS

Features of the present disclosure may be illustrated by way of example and not limited in the following figure(s), in which like numerals indicate like elements, in which:

FIG. 1 illustrates an example of a system of determining directional drivers of deep learning models based on model gradients;

FIG. 2 illustrates a schematic example of feature groupings for gradient-based directional drivers of a deep learning model;

FIG. 3 illustrates a plot of an example of a model function and its gradient;

FIG. 4 illustrates of plots showing examples of directional drivers;

FIG. 5 illustrates an example of an output report showing directional drivers of variable groups;

FIG. 6 illustrates an example of a method of determining directional drivers of deep learning models based on model gradients; and

FIG. 7 illustrates another example of a method of determining directional drivers of deep learning models based on model gradients.

### DETAILED DESCRIPTION

The disclosure relates to systems and methods of determining directional drivers of deep learning models based on model gradients. Deep learning model outputs such as neural network outputs are notoriously difficult to interpret, given the complexity of the models and potentially large number of features. Although true for neural networks generally, these and related or other issues are particularly the case for regression models.

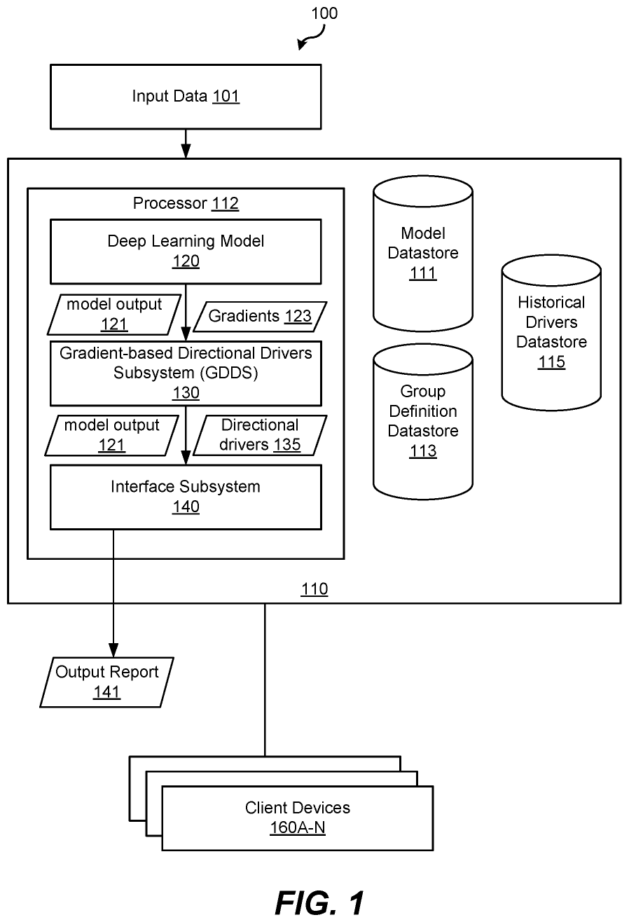

FIG. 1 illustrates an example of a system 100 of determining gradient-based directional drivers of deep learning models. The system 100 may include a computer system 110, one or more client devices 160 (illustrated as client devices 160A-N), and/or other components.

To address the foregoing issues with deep learning models, the computer system 110 may include one or more processors 112, a model datastore 111, a group definition datastore 113, a historical drivers datastore 115, and/or other components. The processor 112 may include one or more of a digital processor, an analog processor, a digital circuit designed to process information, an analog circuit designed to process information, a state machine, and/or other mechanisms for electronically processing information. Although processor 112 is shown in FIG. 1 as a single entity, this is for illustrative purposes only. In some embodiments, processor 112 may comprise a plurality of processing units. These processing units may be physically located within the same device, or processor 112 may represent processing functionality of a plurality of devices operating in coordination.

As shown in FIG. 1, processor 112 is programmed to execute one or more computer program components. The computer program components may include software programs and/or algorithms coded and/or otherwise embedded in processor 112, for example. The one or more computer program components or features may include a deep learning model 120, a Gradient-based Directional Drivers Subsystem (GDDS) 130, an interface subsystem 140, and/or other components or functionality.

Processor 112 may be configured to execute or implement 120, 130, and/or 140 by software; hardware; firmware; some combination of software, hardware, and/or firmware; and/or other mechanisms for configuring processing capabilities on processor 112. It should be appreciated that although 120, 130, and 140 are illustrated in FIG. 1 as being co-located in the computer system 110, one or more of the components or features 120, 130, and 140 may be located remotely from the other components or features. The description of the functionality provided by the different components or features 120, 130, and 140 described below is for illustrative purposes, and is not intended to be limiting, as any of the components or features 120, 130, and 140 may provide more or less functionality than is described, which is not to imply that other descriptions are limiting. For example, one or more of the components or features 120, 130, and 140 may be eliminated, and some or all of its functionality may be provided by others of the components or features 120, 130, and 140, again which is not to imply that other descriptions are limiting. As another example, processor 112 may include one or more additional components that may perform some or all of the functionality attributed below to one of the components or features 120, 130, and 140.

The deep learning model 120 may include different types of machine learning models, including, for example, neural networks. For example, deep learning model 120 may be implemented using various models such as a general recurrent feed forward neural network, a perceptron, a multilayer perceptron, a convolution neural network (CNN), a recurrent neural network (RNN) using Gated Recurrent Units (GRUs), a Long Short Term Memory (LSTM), and/or other types of neural networks that may use activation functions. In these examples, the computer system 110 may determine gradient-based directional drivers of the models as described in this disclosure.

The deep learning model 120 may be trained to generate a model output 121. The training data used for deep learning may include a time series having a sequence of data values. The particular type of data values may vary depending on the specific implementation of the deep learning model 120 and the desired output. Various examples described herein may include a time series of Repo Spread Indicators (RSI) data values or weather data values for illustration. Other types of input data, including non-time series data may be used as well.

The input data 101 may include a plurality of data values that are modeled for prediction by the computer system 110. Like the training data, the input data 101 may include various types of values depending on the context in which the deep learning model 120 is trained and executed. In some examples, the input data 101 may be mapped to activation functions, such as, for example as described in U.S. patent application Ser. No. 17/940,159, filed on Sep. 8, 2022, entitled “MAPPING ACTIVATION FUNCTIONS TO DATA FOR DEEP LEARNING,” the entirety of which is incorporated by reference herein for all purposes. In some examples, the input data 101 may be used to model data discontinuities, such as, for example, as described in U.S. patent application Ser. No. 17/940,126, filed on Sep. 8, 2022, entitled “DEEP LEARNING MODELING WITH DATA DISCONTINUITIES,” the entirety of which is incorporated by reference herein for all purposes. In some examples, the deep learning model 120 may include one or more of the neural networks disclosed in U.S. patent applications Ser. Nos. 17/940,159 and/or 17/940,126.

The deep learning model 120 may include a neural network, which includes a computational learning system that uses a network of neurons to translate input data of one form into a desired output. A neuron may refer to an electronic processing node implemented as a computer function, such as one or more computations.

The neural network may include an input layer that accepts input data, one or more hidden layers, and a fully connected output layer (also referred to as “output layer” for convenience) that generates output data, which may include a prediction relating to the input data. The number of hidden layers used may vary depending on the complexity of the neural network that is used. Various numbers of neurons at each layer may be used. In some examples, at least some of the hidden layers and/or the output layer may be considered a “dense layer.” A dense layer is one in which neurons at that layer receives the output of all neurons of a previous layer. As such, a neuron at a dense layer may be referred to as “fully connected.”

Each hidden layer may include one or more neurons. Each neuron in each of the hidden layers and the output layer may receive (as input) the output of a neuron of a prior layer. The neuron may then apply an activation function to the input data, which is an output of the neuron of the prior layer. The activation function may in turn generate its output based on the input data. This process may continue through to the fully connected output layer in a process referred to as “Feed Forward Propagation.” In some examples, an activation function is applied even at the fully connected output layer to generate the output data. Other numbers of activation functions may be included, depending on the number of layers.

The activation function determines what is fed forward in the neural network to the next neuron (or hidden cell). In other words, an activation function may generate an output at a given neuron based on the output of another neuron at a prior layer of the neural network. A prediction is then made based on which an error metric is calculated. Based on this, weights are updated in what is called back propagation. An example of an activation function, Activation( ), may be given by Equation 1:

$$Y = Activation ( \sum ( Weights * Inputs ) + Bias ) , \qquad ( 1 )$$

in which Weights are learned and updated, Bias is a parameter that shifts the activation function, and Y is the output of a given neuron, which may be fed forward or is an output of the neural network.

In some examples, during back propagation the Weights may be updated based on an error rate observed from a prior epoch as compared to known outcomes in historical data used for training. During the process of backpropagation, the neural network is therefore fine-tuned to learn from the training data. The training process may be iterated N epochs, where N may be a hyperparameter input to the model.

In some examples, the neural network may be implemented as an RNN. The neural network may include activation functions. For example, an activation function may be selected for a given neuron of a given layer in the RNN based on one or more properties of the input data.

In some examples, the model output 121 may include a regression output from an RNN that represents a predicted value for the modeled input data. For example, the model output 121 may include a predicted repo spread indicator (RSI), a predicted weather value, and/or other value. If trained on sequence data having observed data values over time, the deep learning model 120 may output a model output 121 that includes multiple values in a time series. There may be multiple and complex features to the deep learning model 120, resulting in an inability to identify inputs that impact the model output 121.

### Feature Groupings

To address the scale and/or complexity of features to the deep learning model 120, the GDDS 130 may group together features based on a group definition, which may be stored in the group definition datastore 113. A group definition may specify groups of features in which related features are grouped together. The groups of features may be configured as appropriate, such as to determine an impact of groups of features. The groups of features enable monitoring of feature impacts based on logical groupings of features. The logical grouping may reduce the number and complexity of the features when determining the impact of those features.

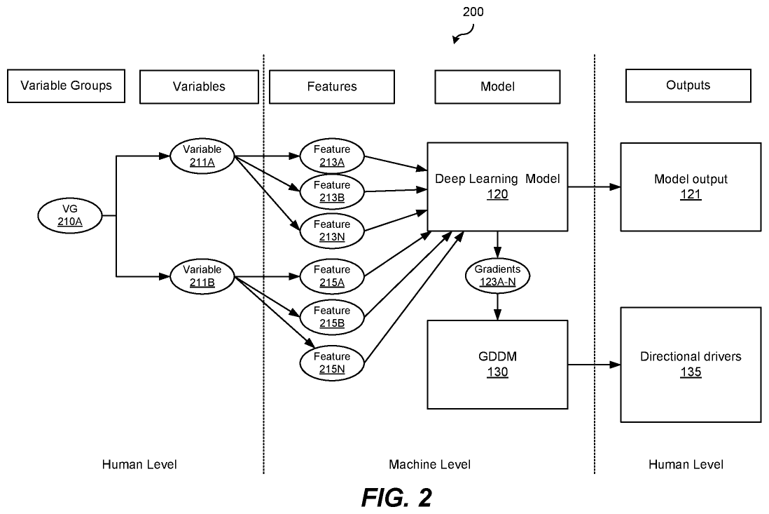

To illustrate, FIG. 2 shows a schematic example 200 of feature groupings for gradient-based directional drivers of a deep learning model 120. As shown in FIG. 2, features 213 and 215 (illustrated as one or more features 213A-N and one or more 215A-N) may be grouped based on respective variables 211A and 211B. Put another way, variable 211A may include a group of features 213A-N and variable 211B may include a group of features 215A-N.

One or more variables 211 may in turn be grouped into respective variable groups 210 (only one variable groups 210A is illustrated for convenience). For example, variables 211A and 211B are grouped into a variable group 210A. Put another way, the variable group 210A may include a group of variables 211A and 211B. Features may be grouped into a hierarchical arrangement having variable groups at a first level in the hierarchy, variables at a second level of the hierarchy, and features at a third level of the hierarchy. The feature groups (such as variables having groups of features and/or variable groups having groups of variables) may be used to aggregate the impact of underlying features on the model output 121, which may reduce the number of features to examine and/or mitigate against the complexity of relationships of the features by grouping features based on the relationships.

The particular types of features 213, 215 and therefore variables 211 and variable groups 210 may vary depending on the context in which the deep learning model 120 is trained and executed. For example, in the context of repo spreads, features 213, 215 may include a level, a 1-day change, a 1-day StD, a 5-day absolute change, a 21-day moving average, and/or other values that may be used as features to predict repo spreads. These and/or other features may be grouped into variables as appropriate by a user to be able to understand how variables (based on their grouped features), and/or groups of variables (based on their grouped variables and corresponding grouped features) impact the model output 121.

In another example, in the context of weather forecasting, variables may include temperature, air pressure, wind speed, wind direction, and/or other data that may impact weather predictions. In a time series, individual features and values of these and/or other variables may impact the model output 121, but changes over time may also impact the prediction. For example, high temperature might be indicative of more high temperature, but when the change in that temperature has been negative over the last few consecutive days, the forecast may change.

In these and other example contexts, the GDDS 130 may apply groupings and identify directional drivers 135 that may explain the model output 121 (such as repo spread predictions, weather forecasts, or other outputs) generated by the deep learning model 120.

### Gradient-Based Directional Drivers

The GDDS 130 may access and use gradients 123 to determine directional drivers 135 of the deep learning model 120. A gradient 123 is a rate of change of a model function based on an input. The model function may be used by the deep learning model 120 to generate the model output 121. Thus, gradients 123 may represent the effect of an input, which may be derived based on a feature, on the output of the model function and therefore the model output 121.

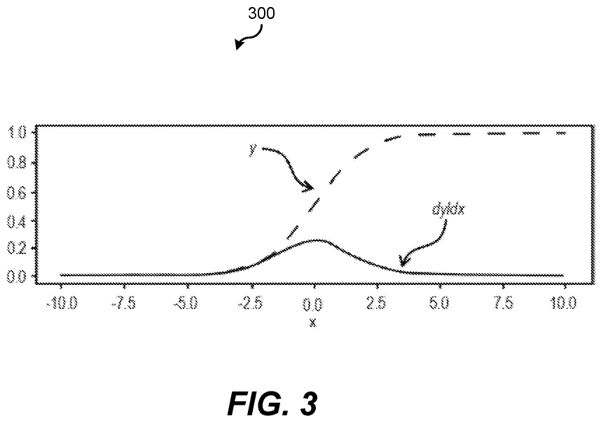

In some examples, the deep learning model 120, or platform that executes the model, may generate a data object that includes gradients 123. An example of a data object is a tensor object, which may be referred to interchangeably in this disclosure as a tensor. Examples of such platforms include, without limitation, TENSORFLOW, MATLAB, RAPIDMINER, PYTORCH, SPARK, and similar platforms that may each generate gradients via respective gradient functions. To differentiate automatically, the platform may store an ordered list of operations that occur during a forward pass of the deep learning model 120. During a backward pass, the platform may traverse the list of operations in reverse order to compute the gradients 123. To illustrate the gradients 123 in the context of a model function, reference will be made to FIG. 3, which illustrates a plot 300 of an example of a model function (sigmoid function) and its gradient 123. A platform may provide a function for automatic differentiation (AD). AD is a set of techniques to evaluate the derivative of the model function. AD operates based on the proposition that computer functions may operate a sequence of elementary arithmetic operations (such as addition, subtraction, multiplication, division, and so forth) and elementary functions (exp, log, sin, cos, and so forth). By applying the chain rule repeatedly to these operations, derivatives of arbitrary order can be computed automatically. AD may use reverse mode (or reverse accumulation), in which the dependent variable to be differentiated is fixed and the derivative is computed with respect to each sub-expression recursively.

The platform may compute a gradient 123 of a computation with respect to inputs, such as derivatives of the sum of ys with respect to x in xs, in which ys and xs are each a tensor or a list of tensors. grad_ys is a list of tensor, holding the gradients received by the ys. The list must be the same length as ys. Those inputs can also be the input variables or features used.

As illustrated, plot 300 shows an example of a model function: the sigmoid function y, given by Equation (2):

$$y = f ( x ) = 1 / ( 1 + e \hat{} ( - x ) ) . \qquad ( 2 )$$

Plot 300 shows the sigmoid function (y) alongside its derivative (dy/dx) that was accessed from the function for AD. In some examples, normalization of the input data may be used to interpret model outputs 121. For example, for repo spread predictions, input values may be quasi-range bound in the range [−300,0], where these values represent basis points. The inverse fit of the scaler transforms spreads from a [0,1]→[−300,0] range. Pre-transformed prediction outputs close to 1 imply tight repo spreads (close to zero) and low prediction output values close to 0 imply wide spreads (closer to −300 bps).

In some examples, the sign (indicating positive or negative) of the gradients 123 may indicate the directionality of the impact on the model output 121 of a feature. For example, positive gradient values mean repo spread tighteners (towards the upper bound of 0 bps). Negative values mean repo spread wideners (towards the lower bound of −300 bps). In some examples, the magnitude of the gradients 123 may provide insights about the extent to which individual features impact the model output 121, such as the predicted repo spreads.

For time series inputs, the gradients 123 may reflect the data sequence. For example, to obtain historically rolling gradient information, the GDDS 130 may retrieve the rolling model inputs (x). The GDDS 130 may execute the deep learning model 120 to generate model outputs 121, and access the gradients 123 of the model outputs 121 with respect to the feature inputs. To illustrate, the GDDS 130 may instantiate the deep learning model 120 with monitoring of gradients 123. For example, the GDDS 130 may instantiate the deep learning model 120 with the gradient function of the platform set to be activated, which instructs the platform to record gradients 123 via a tensor. Each tensor may have the shape [batch size, time steps, features]. The GDDS 130 may average the gradients 123 across the temporal dimension and collapse the tensor from three-dimensions to two-dimensions having the shape [batch size, features]. For each time step, there may be one average gradient value per feature. The GDDS 130 may access the feature group definition and then aggregate the gradients 123 to variables and/or variable groups according to the feature group definition. For example, the GDDS 130 may loop through the features and corresponding gradients 123 and group each feature and its corresponding gradient 123 into its variable as specified in the feature group definition. In some examples, the GDDS 130 may assign each of these variables into its variable group as specified in the feature group definition. Thus, the GDDS 130 may roll up a gradient 123 associated with a feature into a variable so that the variable is associated with gradients 123 of its assigned features. For example, referring to FIG. 2, the variable 211A will be associated with the gradients 123 corresponding to the features 213A-N. Similarly, in some examples, the GDDS 130 may roll up the gradients 123 associated with variables into variable groups so that a variable group is associated with the gradients 123 of the underlying variables. Again referring to FIG. 2, the variable group 210A will be associated with the gradients 221 corresponding to the features 213A-N(from variable 211A) and the gradients 221 corresponding to the features 215A-N(from variable 211B). The GDDS 130 may continue such roll-up aggregation for all variables and/or variable groups specified in the feature group definition.

Tables 1-3 below illustrate examples processing in the context of example 5-year Treasury auction 1-week prediction (5 business day time steps) with gradients in [1,5,25] shape for [batch size, input time steps, features], which after collapsing along the time step axis becomes an array of shape [1,25] with one value for each feature.

Table 1 illustrates an example of model outputs 121:

Model outputs

```
<tensor: shape(1, 5, 1), dtype=float32, numpy=
array([[[0.91575515],
  [0.9179286 ],
  [0.8973157 ],
  [0.87672424],
  [0.8771186 ]]], dtype=float32)>
```

Once the model outputs are generated, the GDDS 130 may access gradients 123 associated with the model outputs illustrated in Table 1. Examples of these gradients 123 are illustrated in Table 2:

N-dimensional Gradients

```
<tensor: shape=(1, 5, 25), dtype=float32, numpy=
array([[[ 4.83369946e−01, −7.9527420e−02, 1.93465903e−01,
  −1.03968687e−01, −1.13545865e−01, 2.4588808e−02,
  −1.64240040e−02, −1.31796554e−01, −6.63942322e−02,
  −5.44133820e−02 −7.30510205e−02, −1.11518234e−01
  −1.41659938e−03 −1.22499272e−01, 6.22947440e−02,
  −1.36397183e−02, 8.24475661e−02, −1.09941177e−02,
  1.70403719e−01, 4.61614393e−02, 1.19160414e−01,
  6.69755228e−03, −7.95209780e−03, −8.51905346e−02,
  9.58970934e−02]]], dtype=float32)>
```

The GDDS 130 may then collapse the tensor from three-dimensions to two-dimensions, as illustrated in Table 3:

N-1 dimensional Gradients after collapsing

```
array([ 9.3280298e−01 −2.3406124e−02, 1.8591769e−01, −2.4405637e−01,
  −2.2190478e−01, 1.8562173e−02, −5.2223898e−02, −1.9329333e−01,
  −8.6752132e−02, −8.1945479e−02, −1.9868158e−01, −1.6022946e−01,
  1.3641962e−01, −9.1233090e−02, 1.5858641e−01, −4.8045896e−02,
  1.1795235e−01, −6.4624770e−04, 1.8360347e−02, 7.5410314e−02,
  1.3161871e−01, 2.6555646e−02, 3.2677166e−02, −6.6504434e−02,
  −1.8927127e−03], dtype=float32)
```

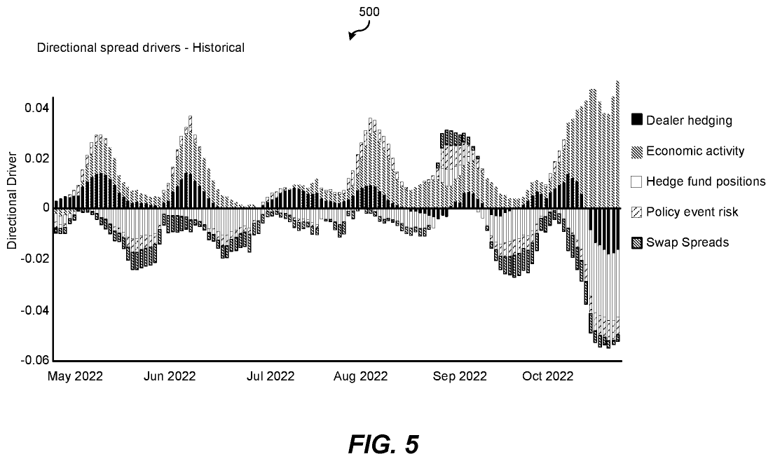

The interface subsystem 140 may generate an output report 141. The output report 141 may include content that explains the model output 121. For example, the output report 141 may include the directional drivers 135 generated by the GDDS 130. An example of an output report 141 is illustrated in FIG. 5. The computer system 110 may transmit the output report 141 to the client device 160.

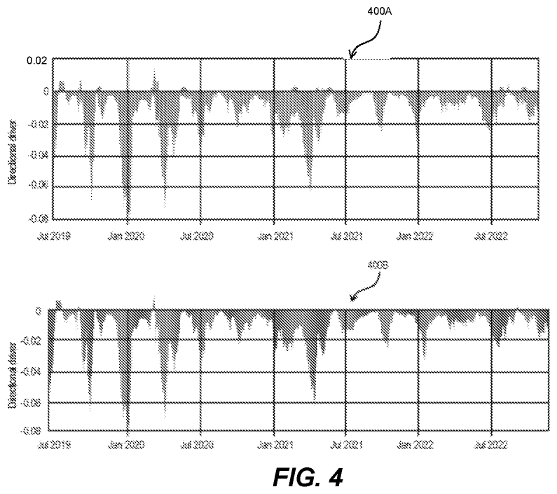

FIG. 4 illustrates plots 400A and 400B showing examples of directional drivers. Assume a variable called Put-Call Ratio (PCR) which expresses how many puts and how many calls are trading for a given futures contract. Futures can be convenient products to express long (bullish) vs. short (bearish) views on a market. High PCR indicates a short demand overhang and may be a strong signal for repo spread widening/specialness. This example illustrates how PCR related features may impact the repo spread prediction for a 10-year Note 1 month ahead.

Plot 400A shows two example features that were calculated based on PCR: the first feature is the level and the second feature is the 1-month (21 trading days) change in that level. Negative signals are created. While most of the time these negative signals are benign (>−0.02), occasionally they spike to a range of −0.06 to −0.08. The level itself only gives weak signals, while the change accounts for much of the total signal from that variable.

Both signals are very asymmetric which is due to the range boundedness of repo spreads, together with the fact that many variables used by design are spread wideners-only. As for the latter, they can be interpreted as on/off variables: When off (or close to zero), they produce weak signals (repo spreads close to zero), but when absolutely large produce strong signals (widening spreads) as shown in the plot 400B.

FIG. 5 illustrates an example of an output report 500 showing directional drivers of variable groups. In this example, the output report 500 shows outputs of a repo spread prediction model. 10-15 variable groups were used, only a subset of these groups (auction cycle, cash-futures basis, dealer hedging, economic activity, flows/positions, hedge fund positions, inflation, monetary policy, OT rich/cheap, policy event risk, seasonality, spread momentum, and swap spreads) is shown for ease of illustration. Each variable group contains between 1-3 variables and 1-3 features per variable. The aggregation renders the data in a meaningful way that is easily interpretable by humans. The time variance in each variable group and relative magnitude across groups helps in creating a better understanding for systematic trends in the data. For example, economic activity over the time period shown has been mostly a spread tightener (positive gradient information). Dealer hedging activity has been mostly a spread tightener, but in recent days has turned to be a spread widener.

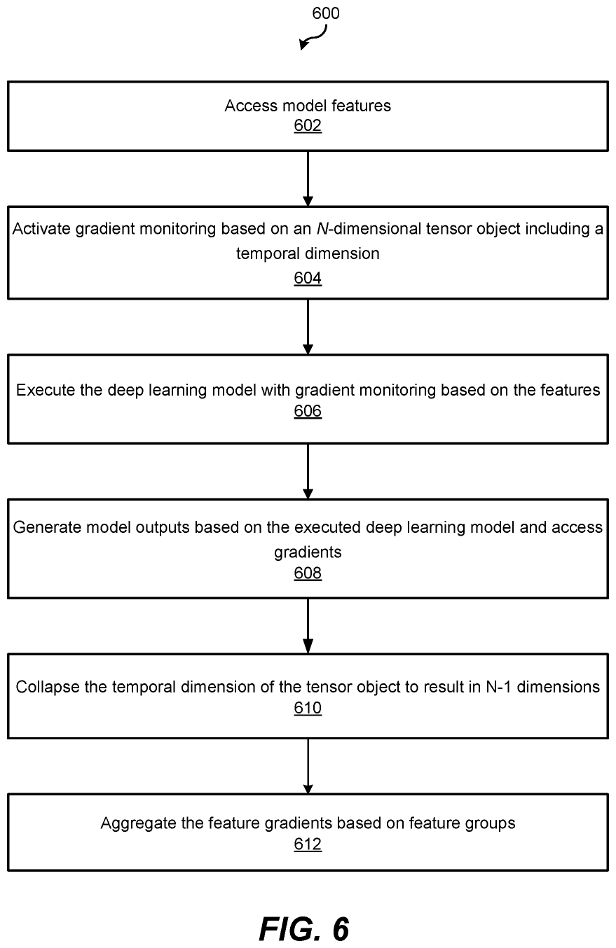

FIG. 6 illustrates an example of a method of determining gradient-based directional drivers of deep learning models.

At 602, the method 600 may include accessing features (such as features 213, 215 illustrated in FIG. 2) for input to a deep learning model 120.

At 604, the method 600 may include activating gradient monitoring on an N-dimensional tensor object including a temporal dimension, where N is an integer greater than two. Other dimensions may include batch size, the features, and/or other dimensions. Gradient monitoring may be activated via a gradient function.

At 606, the method 600 may include executing the deep learning model with gradient monitoring based on the features. At 608, the method 600 may include generating model outputs 121 based on the executed deep learning model and access gradients 123. Table 1 shows examples of model outputs 121 and Table 2 shows examples of gradients 123.

At 610, the method 600 may include collapsing the temporal dimension of the tensor object to result in N−1 dimensions. An example of gradients 123 after collapsing is shown in Table 3. At 610, the method 600 may include aggregating the feature gradients based on feature groups defined in a group definition.

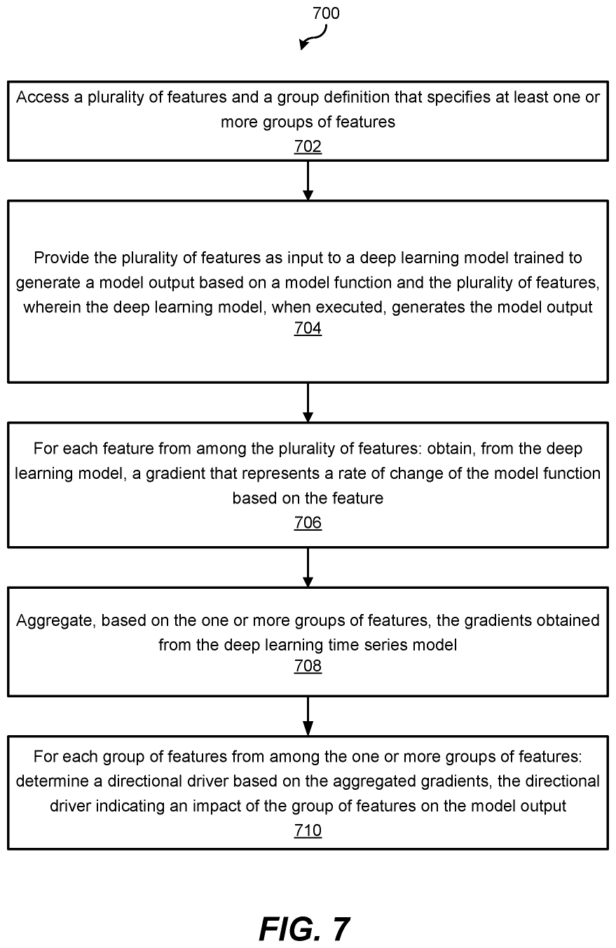

FIG. 7 illustrates another example of a method of determining gradient-based directional drivers of deep learning models. At 702, the method 700 may include accessing a plurality of features obtained and a group definition that specifies a one or more groups of features.

At 704, the method 700 may include providing the plurality of features as input to a deep learning model trained to generate a model output for the time period based on a model function and the plurality of features, the deep learning model when executed generates the model output. At 706, the method 700 may include for each feature from among the plurality of features: obtaining from the deep learning model, a gradient that represents a rate of change of the model function based on the feature.

At 708, the method 700 may include aggregating, based on the one or more groups of features, the gradients obtained from the deep learning model. At 710, the method 700 may include, for each group of features from among the one or more groups of features: determining a directional driver based on the aggregated gradients, the directional driver indicating an impact of the group of features on the model output.

The systems and processes are not limited to the specific examples described herein. In addition, components of each system and each process can be practiced independent and separate from other components and processes described herein. Each component and process also can be used in combination with other assembly packages and processes. The flow charts and descriptions thereof herein should not be understood to prescribe a fixed order of performing the method blocks described therein. Rather the method blocks may be performed in any order that is practicable including simultaneous performance of at least some method blocks. Furthermore, each of the methods may be performed by one or more of the system components illustrated in FIG. 1

The computer system 110 and the one or more client devices 160 may be connected to one another via a communication network (not illustrated), such as the Internet or the Internet in combination with various other networks, like local area networks, cellular networks, or personal area networks, internal organizational networks, and/or other networks. It should be noted that the computer system 110 may transmit data, via the communication network, conveying the predictions one or more of the client devices 160. The data conveying the predictions may be a user interface generated for display at the one or more client devices 160, one or more messages transmitted to the one or more client devices 160, and/or other types of data for transmission. Although not shown, the one or more client devices 160 may each include one or more processors, such as processor 112.

The datastores (such as 111, 113, 115) may be a database, which may include, or interface to, for example, an Oracle™ relational database sold commercially by Oracle Corporation. Other databases, such as Informix™, DB2 or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The database may comprise one or more such databases that reside in one or more physical devices and in one or more physical locations. The datastores may include cloud-based storage solutions. The database may store a plurality of types of data and/or files and associated data or file descriptions, administrative information, or any other data. The various datastores may store predefined and/or customized data described herein.

Each of the computer system 110 and client devices 160 may also include memory in the form of electronic storage. The electronic storage may include non-transitory storage media (also referred to as medium) that electronically stores information. The electronic storage media of the electronic storages may include one or both of (i) system storage that is provided integrally (e.g., substantially non-removable) with servers or client devices or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storage may store software algorithms, information determined by the processors, information obtained from servers, information obtained from client devices, or other information that enables the functionalities described herein.

This written description uses examples to disclose the implementations, including the best mode, and to enable any person skilled in the art to practice the implementations, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system, comprising:
a processor programmed to:
access a plurality of features and a group definition that specifies at least one or more groups of features;
provide the plurality of features as input to a deep learning model trained to generate a model output based on a model function and the plurality of features, wherein the deep learning model, when executed, generates the model output;
for each feature from among the plurality of features:
obtain a gradient that represents a rate of change of the model function based on the feature;
aggregate, based on the one or more groups of features, the gradients obtained from the deep learning model; and
for each group of features from among the one or more groups of features:
determine a directional driver based on the aggregated gradients, the directional driver indicating an impact of the group of features on the model output.

2. The system of claim 1, wherein the gradients are stored in a data object in three dimensions of batch size, input time steps corresponding to a time period, and the plurality of features.

3. The system of claim 2, wherein the processor is further programmed to:
collapse the data object storing the gradients from three dimensions into a two dimensional array shaped by the batch size and the plurality of features.

4. The system of claim 3, wherein to collapse the data object, the processor is further programmed to:
average the gradients across the time dimension.

5. The system of claim 1, wherein the group definition specifies a hierarchical grouping of features comprising:
a first level having one or more variable groups each comprising a plurality of variables;
a second level having each variable from among the plurality of variables, each variable comprising a group of features; and
a third level comprising the features.

6. The system of claim 5, wherein to aggregate, based on the one or more groups of features, the gradients obtained from the deep learning model, the processor is further programmed to:
for each variable from among the plurality of variables, aggregate the gradients of the group of features pertaining to the variable; and
for each variable group, aggregate the aggregate gradients of the plurality of variables pertaining to the variable group,
wherein each directional driver indicates an impact of each variable group on the model output.

7. The system of claim 6, wherein the processor is further programmed to:
generate an output report based on the directional drivers for the variable groups, the output report visually showing an impact of each variable group on the model output.

8. The system of claim 7, wherein the processor is further programmed to:
store the directional drivers along with historical directional drivers over time, wherein the output report includes the directional drivers and historical directional drivers.

9. The system of claim 1, wherein each directional driver comprises a positive value or a negative value, and wherein the processor is further programmed to:
determine, for each directional driver, whether the impact is positive or negative based on the positive value or the negative value.

10. The system of claim 1, wherein the processor is further programmed to:
determine, for each directional driver, a magnitude of the impact based on a value of the directional driver.

11. A method, comprising:
accessing, by a processor, a plurality of features and a group definition that specifies at least one or more groups of features;
providing, by the processor, the plurality of features as input to a deep learning model trained to generate a model output based on a model function and the plurality of features, wherein the deep learning model, when executed, generates the model output;
for each feature from among the plurality of features:
obtaining, by the processor, a gradient that represents a rate of change of the model function based on the feature;
aggregating, by the processor, based on the one or more groups of features, the gradients obtained from the deep learning model; and
for each group of features from among the one or more groups of features:
determining, by the processor, a directional driver based on the aggregated gradients, the directional driver indicating an impact of the group of features on the model output.

12. The method of claim 11, wherein the gradients are stored in a data object in three dimensions of batch size, input time steps corresponding to a time period, and the plurality of features.

13. The method of claim 12, further comprising:
collapsing the data object storing the gradients from three dimensions into a two dimensional array shaped by the batch size and the plurality of features.

14. The method of claim 13, wherein collapsing the data object comprises:
averaging the gradients across the time dimension.

15. The method of claim 11, wherein the group definition specifies a hierarchical grouping of features comprising:
a first level having one or more variable groups each comprising a plurality of variables;
a second level having each variable from among the plurality of variables, each variable comprising a group of features; and
a third level comprising the features.

16. The method of claim 15, wherein aggregating, based on the one or more groups of features, the gradients obtained from the deep learning model comprises:
for each variable from among the plurality of variables, aggregating the gradients of the group of features pertaining to the variable; and
for each variable group, aggregating the aggregate gradients of the plurality of variables pertaining to the variable group,
wherein each directional driver indicates an impact of each variable group on the model output.

17. The method of claim 16, further comprising:
generating an output report based on the directional drivers for the variable groups, the output report visually showing an impact of each variable group on the model output.

18. The method of claim 11, wherein each directional driver comprises a positive value or a negative value, the method further comprising:
determining, for each directional driver, whether the impact is positive or negative based on the positive value or the negative value.

19. The method of claim 11, further comprising:
determining, for each directional driver, a magnitude of the impact based on a value of the directional driver.

20. A non-transitory storage medium storing instructions that, when executed by a processor, programs the processor to:
access a plurality of features and a group definition that specifies at least one or more groups of features;
provide the plurality of features as input to a deep learning model trained to generate a model output based on a model function and the plurality of features, wherein the deep learning model, when executed, generates the model output;
for each feature from among the plurality of features:
obtain, from the deep learning model, a gradient that represents a rate of change of the model function based on the feature;
aggregate, based on the one or more groups of features, the gradients obtained from the deep learning model; and
for each group of features from among the one or more groups of features:
determine a directional driver based on the aggregated gradients, the directional driver indicating an impact of the group of features on the model output.
